(19) United States
(12) Patent Application Publication
(10) Pub. No.: US 2004/0264352 A1
(43) Pub. Date: Dec. 30, 2004

(54) Optical pickup apparatus

(76) Inventor: Masayoshi Ohya, Higashihiroshima-shi (JP)

Correspondence Address: MORRISON & FOERSTER LLP, 755 PAGE MILL RD, PALO ALTO, CA, 94304-1018, US

(21) Appl. No.: 10/846,333

(22) Filed: May 14, 2004

(30) Foreign Application Priority Data
May 15, 2003 (JP) P2003-137033

(51) Int. Cl. G11B 7/00

(52) U.S. Cl. 369/112.23; 369/44.15

(57) ABSTRACT

An object of the invention is to provide an optical pickup apparatus in which a condensing lens can be bonded with as large an adhesive coating area as possible. The optical pickup apparatus includes a condensing lens for gathering light emitted from a light source on an optical recording medium, and a lens holder for supporting the condensing lens. The condensing lens has, in an outer periphery in a radial direction thereof, a plurality of lens-side concavities equi-spaced circumferentially so as to open to face the optical recording medium. That part of the condensing lens which faces the lens-side concavity is bonded to the lens holder with an adhesive.

### BACKGROUND OF THE INVENTION

1. Field of the Invention

The present invention relates to an optical pickup apparatus designed for use in reading, writing, and erasing information with respect to an optical recording medium.

2. Description of the Related Art

FIG. 12 is a plan view showing a condensing lens 1 and a lens holder 2 that are mounted in an optical pickup apparatus according to one related art. FIG. 13 is a sectional view taken along the line S13-S13 of FIG. 12. The optical pickup apparatus (its whole body is not shown in the figure) is mounted in optical recording medium recording/reproducing equipment for reading, writing, and erasing information with respect to an optical recording medium such as a compact disc (abbreviated as CD), a digital versatile disc (abbreviated as DVD), and the like. In the optical pickup apparatus, the condensing lens 1, which gathers light emitted from a light source (not shown) on an optical recording medium, is attached to the lens holder 2 which is coupled to a driving mechanism (not shown) in the following manner. As shown in FIG. 12, with use of adhesive 3, an outer periphery in a radial direction la of the condensing lens 1 and the lens holder 2 are bonded to each other at two positions corresponding to both ends in a y direction of the condensing lens 1, which y direction is one of the directions perpendicular to an axis of the condensing lens 1 (refer to Japanese Unexamined Patent Publication JP-A 2001-228387, for example).

FIG. 14 is a plan view showing a lens 1A and a lens holder 2A that are mounted in an optical pickup apparatus according to another related art. In the optical pickup apparatus (its whole body is not shown in the figure), two pieces of guide-portions 4 for positioning the condensing lens 1A are provided to secure adequate space for bonding the condensing lens 1A to the lens holder 2A. The guide portions 4 are disposed respectively on an outer side in a radial direction of the condensing lens 1A so as to be located on both sides in an x direction of the condensing lens 1A, which x direction is one of the directions perpendicular to an axis of the condensing lens 1A.

Recently, as the demand for low-profile notebook-type personal computers grows, miniaturization has been demanded of optical pickup apparatuses designed to be mountable in such equipment. To achieve miniaturization, the optical pickup apparatus has come to have, instead of two types of laser light sources provided for both CD and DVD, a single laser light source with use of a two-wavelength laser. As a natural consequence of this trend, compactness has been sought after also in a housing and a lens holder, in which no restriction has hitherto been placed on the formation of an adhesive coating area which is required for attaching an optical member such as a condensing lens to the optical pickup apparatus.

In the related art shown in FIGS. 12 and 13, with use of the adhesive 3, the outer periphery in the radial direction la of the condensing lens 1 and the lens holder 2 are bonded to each other at two positions corresponding to both ends in the y direction of the condensing lens 1. In this structure, a tensile stress is generated in the y direction with respect to the condensing lens 1. Thus, in a case where the condensing lens 1 is made of a synthetic resin, it is likely that the condensing lens 1 becomes deformed in the x direction perpendicular to the axis and the y direction. Furthermore, since the condensing lens 1 and the lens holder 2 are bonded to each other only at two positions, it is difficult to increase the adhesive coating area.

On the other hand, in the other related art shown in FIG. 14, two pieces of guide portions 4 are disposed respectively on the outer side in the radial direction of the condensing lens 1A so as to be located on both sides in the x direction thereof. Here, it is assumed that the amount of displacement as seen in the x direction is Tx and that the amount of displacement as seen in the y direction perpendicular to the axis of the condensing lens 1A and the x direction is Ty. In this case, the amount of the displacement Ty in the y direction is larger than the amount of displacement Tx in the x direction. As a result, there is a high risk that the axis of the condensing lens 1A deviates from the desired position. In the case where the condensing lens 1A has a sufficiently large effective diameter, the influence of the positional deviation is so little that it can be disregarded. However, in the case where the effective diameter of the condensing lens 1A is unduly small, the influence of the positional deviation is too great to be disregarded.

### SUMMARY OF THE INVENTION

Accordingly, an object of the invention is to provide an optical pickup apparatus in which a condensing lens can be bonded to a lens holder with its positional deviation kept as small as possible by increasing the adhesive coating area between the condensing lens and the lens holder, and also provide an electronic apparatus having the optical pickup apparatus mounted therein.

The invention provides an optical pickup apparatus comprising:

a condensing lens for gathering light emitted from a light source on an object to be irradiated; and

a lens holder for supporting the condensing lens,

wherein the condensing lens has, in an outer periphery in a radial direction thereof, a lens-side concavity formed so as to open to face the object to be irradiated,

and wherein that part of the condensing lens which faces the lens-side concavity is bonded to the lens holder with use of an adhesive.

According to the invention, the condensing lens has, in the outer periphery in the radial direction thereof, the lens-side concavity formed so as to open to face the object to be irradiated, and that part of the condensing lens which faces the lens-side concavity is bonded to the lens holder with use of the adhesive. In this construction, as compared with the case where no lens-side concavity is formed, the contact area between the condensing lens and the adhesive can be made wider. Therefore, the condensing lens can be supported upon the lens holder with stability.

The invention provides an optical pickup apparatus comprising:

a condensing lens for gathering light emitted from a light source on an object to be irradiated; and

a lens holder for supporting the condensing lens,

wherein the condensing lens has, in an outer periphery in a radial direction thereof which outer periphery faces the object to be irradiated, a lens-side concavity formed so as to open to face the lens holder,

wherein the lens holder has a holder-side concavity formed therein so as to open to face the lens-side concavity,

and wherein that part of the condensing lens which faces the lens-side concavity is bonded to that part of the lens holder which faces the holder-side concavity with use of an adhesive.

According to the invention, the condensing lens has, in the outer periphery in the radial direction thereof which outer periphery faces the object to be irradiated, the lens-side concavity formed so as to open to face the lens holder, and the lens holder has the holder-side concavity formed therein so as to open to face the lens-side concavity. Moreover, that part of the condensing lens which faces the lens-side concavity is bonded to that part of the lens holder which faces the holder-side concavity with use of the adhesive. In this construction, as compared with the case where neither the lens-side concavity nor the holder-side concavity is formed, the contact area between the condensing lens and the adhesive can be made wider. Therefore, the condensing lens can be supported upon the lens holder with stability.

In the invention, the condensing lens is provided with a regulatory portion for regulating that the adhesive is placed on an object-to-be-irradiated side beyond a surface of the condensing lens facing the object to be irradiated.

According to the invention, the condensing lens is provided with the regulatory portion for regulating that the adhesive is placed on the object-to-be-irradiated side beyond the surface of the condensing lens facing the object to be irradiated. This makes it possible to prevent the adhesive from jutting into the object-to-be-irradiated side beyond the surface of the condensing lens facing the object to be irradiated, and thereby keep the adhesive out of contact with the object to be irradiated without fail.

In the invention, the condensing lens is provided with three or more lens-side concavities that are equally spaced circumferentially.

According to the invention, the condensing lens is provided with three or more lens-side concavities that are equally spaced circumferentially. This allows, in the state in which the condensing lens is bonded to the lens holder, the radial stress exerted on the condensing lens to be uniformly distributed throughout the circumference thereof, and thereby minimizes the possibility of the condensing lens being deformed.

In the invention, one of the lens-side concavities is configured differently from the other lens-side concavities.

According to the invention, one of the lens-side concavities is configured differently from the other lens-side concavities. Thus, at the time when the condensing lens is bonded to the lens holder, the differently configured lens-side concavity serves as a mark for facilitating proper positioning.

In the invention, a guide member is detachably attached to that part of the lens holder facing the lens-side concavity so as to protrude in a direction toward the object to be irradiated, and

a lens protective member is guided by the guide member so that the lens protective member is arranged on the object-to-be-irradiated side with respect to the surface of the condensing lens facing the object to be irradiated.

According to the invention, the lens protective member can be attached to the lens holder with ease in the following manner. At first, the guide member is attached to that part of the lens holder which faces the lens-side concavity so as to protrude in the direction toward the object to be irradiated. Then, the lens protective member is guided by the guide member so that it is arranged on the object-to-be-irradiated side with respect to the surface of the condensing lens facing the object to be irradiated. In addition, such a lens protective member is useful in preventing the condensing lens from abutting against the object to be irradiated.

The invention provides an optical pickup apparatus comprising:

a condensing lens for gathering light emitted from a light source on an object to be irradiated; and

a lens holder for supporting the condensing lens,

wherein the condensing lens has, in an outer periphery in a radial direction thereof, a through hole formed so as to open to face the object to be irradiated and the lens holder,

and wherein a through hole formed portion of the condensing lens in which the through hole is formed is bonded to the lens holder with use of an adhesive.

According to the invention, the condensing lens has, in the outer periphery in the radial direction thereof, the through hole formed so as to open to face the object to be irradiated and the lens holder, and a through hole formed portion of the condensing lens in which the through hole is formed is bonded to the lens holder with use of the adhesive. In this construction, as compared with the case where no through hole is formed, the contact area between the condensing lens and the adhesive can be made wider. Therefore, the condensing lens can be supported upon the lens holder with stability.

In the invention, the through hole is so shaped that its part facing the lens holder is made larger in diameter than the rest part thereof.

According to the invention, the through hole is so shaped that its part facing the lens holder is made larger in diameter than the rest part thereof. This makes it possible to increase the adhesive coating area between the lens holder and the through hole formed portion. Therefore, the condensing lens can be supported upon the lens holder with more stability.

In the invention, the lens holder is provided with a guide portion which extends along the entire circumference of the condensing lens from an outer side in the radial direction thereof so as to encircle the condensing lens.

According to the invention, the lens holder is provided with the guide portion which extends along the entire circumference of the condensing lens from the outer side in the radial direction thereof so as to encircle the condensing lens. Thus, in contrast to the case where the guide portion is disposed only in a given radial location, the condensing lens can be positioned with respect to the lens holder with maximum accuracy.

In the invention, the lens protective member is formed in an annular shape and is attached to the guide portion.

According to the invention, the lens protective member is formed in the annular shape and is attached to the guide portion. This makes it possible to prevent the condensing lens from abutting against the object to be irradiated without fail.

In the invention, the optical pickup apparatus further comprises a lens protective member formed in an annular shape,

wherein the lens protective member is attached to the lens holder so that the lens protective member is arranged on the object-to-be-irradiated side with respect to a surface of the condensing lens facing the object to be irradiated and on an outer side in the radial direction of the condensing lens.

According to the invention, the lens protective member is formed in the annular shape and is attached to the lens holder so that the lens protective member is arranged on the object-to-be-irradiated side with respect to the surface of the condensing lens facing the object to be irradiated and on the outer side in the radial direction of the condensing lens. This makes it possible to prevent the condensing lens from abutting against the object to be irradiated without fail.

In the invention, the condensing lens is provided with a lens-side regulatory portion for regulating that adhesive flows inward in the radial direction of the condensing lens.

According to the invention, the condensing lens is provided with the lens-side regulatory portion for regulating that the adhesive flows inward in the radial direction of the condensing lens. This makes it possible to prevent the adhesive from flowing toward the light-transmitting portion on the inner side in the radial direction of the condensing lens, and thereby minimize the possibility of the light being inhibited from transmission.

The invention further provides an electronic apparatus having the aforementioned optical pickup apparatus mounted therein.

According to the invention, the electronic apparatus is designed to mount therein the optical pickup apparatus that has succeeded in accomplishing the advantageous effects as stated above.

### BRIEF DESCRIPTION OF THE DRAWINGS

Other and further objects, features, and advantages of the invention will be more explicit from the following detailed description taken with reference to the drawings wherein:

FIG. 1 is a sectional view schematically showing an optical pickup apparatus according to a first embodiment of the invention;

FIG. 2 is an enlarged plan view showing a lens holder and a condensing lens;

FIG. 3 is a sectional view taken along the line S3-S3 of FIG. 2;

FIG. 4 is an enlarged plan view showing a lens holder and a condensing lens employed in an optical pickup apparatus according to a second embodiment of the invention;

FIG. 5 is a sectional view taken along the line S5-S5 of FIG. 4;

FIG. 6 is an enlarged sectional view showing part of a lens holder and a condensing lens employed in an optical pickup apparatus according to a third embodiment of the invention;

FIG. 7 is an enlarged plan view showing a lens holder and a condensing lens employed in an optical pickup apparatus according to a fourth embodiment of the invention;

FIG. 8 is a sectional view taken along the line S8-S8 of FIG. 7;

FIG. 9 is a sectional view showing a collimator lens employed in the optical pickup apparatuses according to the first to fourth embodiments;

FIG. 10A is a side view showing one embodiment of the collimator lens;

FIG. 10B is a front view showing one embodiment of the collimator lens;

FIG. 11A is a side view showing another embodiment of the collimator lens;

FIG. 11B is a front view showing another embodiment of the collimator lens;

FIG. 12 is a plan view showing the condensing lens and the lens holder that are mounted in the optical pickup apparatus according to one related art;

FIG. 13 is a sectional view taken along the line S13-S13 of FIG. 12; and

FIG. 14 is a plan view showing the lens and the lens holder that are mounted in an optical pickup apparatus according to another related art.

### DETAILED DESCRIPTION

Now referring to the drawings, preferred embodiments of the invention are described below.

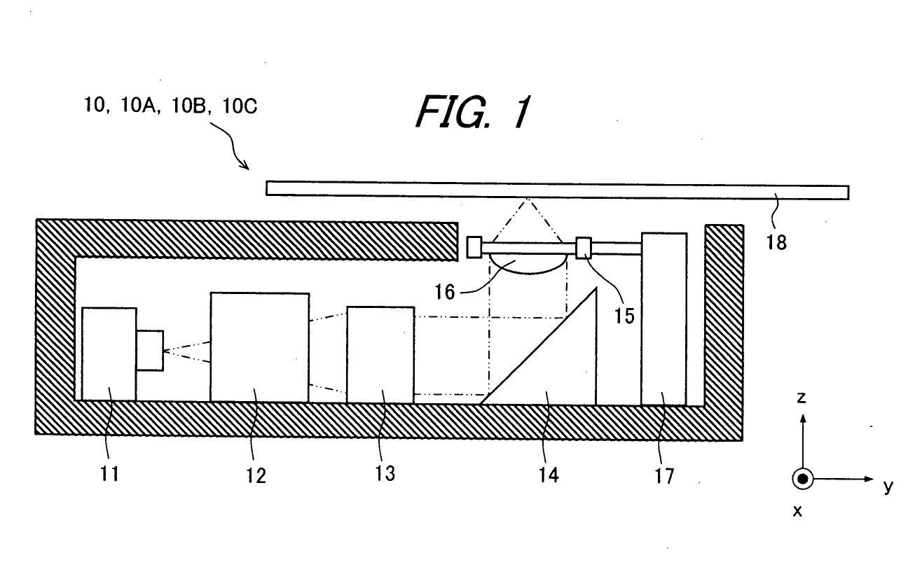

FIG. 1 is a sectional view schematically showing an optical pickup apparatus 10 according to a first embodiment of the invention. The optical pickup apparatus 10 is designed to be mounted in optical recording medium recording/reproducing equipment, or equivalently an electronic apparatus for reading, writing, and erasing information with respect to an optical recording medium such as a Compact Disc (abbreviated as CD), a Digital Versatile Disc (abbreviated as DVD), and the like. The optical pickup apparatus 10 includes a light emitting/receiving portion 11, a dichroic prism 12, a collimator lens 13, a raising mirror 14, a lens holder 15, a condensing lens 16, and a driving mechanism 17.

The light emitting/receiving portion 11 is composed of a light-emitting element and a light-receiving element. The light-emitting element emits two types of laser light of different wavelengths required for recording and reading information on both CD and DVD. The light-receiving element photoelectrically converts incident light. The dichroic prism 12 directs the light from the light emitting/receiving portion 11 to the collimator lens 13, and also directs the light from the collimator lens 13 to the light emitting/receiving portion 11. The collimator lens 13 converts the light from the light emitting/receiving portion 11 directed through the dichroic prism 12 into parallel light. The raising mirror 14 reflects the light from the collimator lens 13 so that it may be directed to the condensing lens 16. The lens holder 15 is coupled to the driving mechanism 17 to support the condensing lens 16. The condensing lens 16 gathers the light reflected from the raising mirror 14 on an object to be irradiated, namely, an optical recording medium 18. The driving mechanism 17 drives the lens holder 15 for supporting the condensing lens 16 to displace.

The light emitted from the light emitting/receiving portion 11 is directed through the dichroic prism 12 to the collimator lens 13. Through the collimator lens 13, the light from the dichroic prism 12 is converted into parallel light, and is then directed to the raising mirror 14. The light that has entered the raising mirror 14 through the collimator lens 13 is reflected therefrom toward the condensing lens 16. Through the condensing lens 16, the light from the raising mirror 14 converges to be shone onto the information recording surface of the optical recording medium 18.

The light reflected from the information recording surface of the optical recording medium 18 is incident on the condensing lens 16. Through the condensing lens 16, the light from the optical recording medium 18 is converted into parallel light, and is then directed to the raising mirror 14. The light that has entered the raising mirror 14 through the condensing lens 16 is reflected therefrom toward the collimator lens 13. The light that has entered the collimator lens 13 through the raising mirror 14 is incident on the light emitting/receiving portion 11 through the dichroic prism 12. The light incident on the light emitting/receiving portion 11 is subjected to photoelectric conversion, thereby generating an electric signal. The electric signal is used to read out, record, and erase information, and also used as a servo signal.

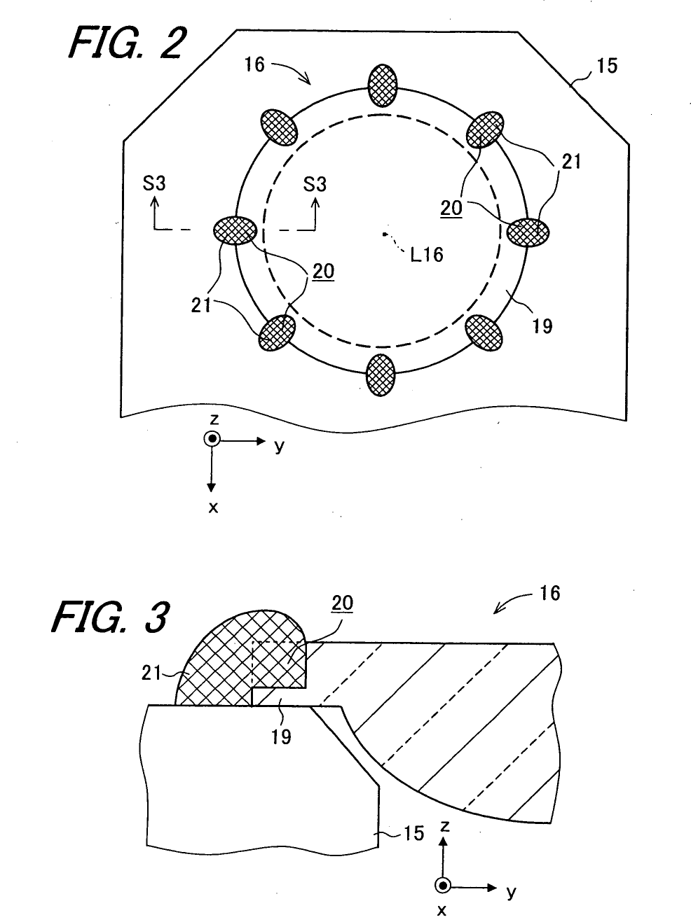

FIG. 2 is an enlarged plan view showing the lens holder 15 and the condensing lens 16. FIG. 3 is a sectional view taken along the line S3-S3 of FIG. 2. In these drawings together with FIG. 1 to which reference is now made, the condensing lens 16 has, in several positions about an outer periphery in a radial direction 19 thereof, three pieces or more (eight pieces, in this embodiment) of lens-side concavities 20 equi-spaced circumferentially so as to open to face the optical recording medium 18. With use of an adhesive 21, that part of the condensing lens 16 which faces the lens-side concavity 20 is bonded to the lens holder 15.

Specifically, the lens-side concavity 20 is so formed as to open outward in the radial direction to face the optical recording medium 18. More specifically, the lens-side concavity 20 is sunk inward in the radial direction, and the surface of the condensing lens 16 facing the lens-side concavity 20 from an inner side in the radial direction is so shaped as to have a substantially cylindrical inner peripheral surface whose axis is parallel to the axis L16 of the condensing lens 16. In this way, the surface of the condensing lens 16 facing the lens-side concavity 20 is smoothed out, whereby making it possible to minimize the risk of damage to the condensing lens 16 caused by the stress concentration exerted on that part.

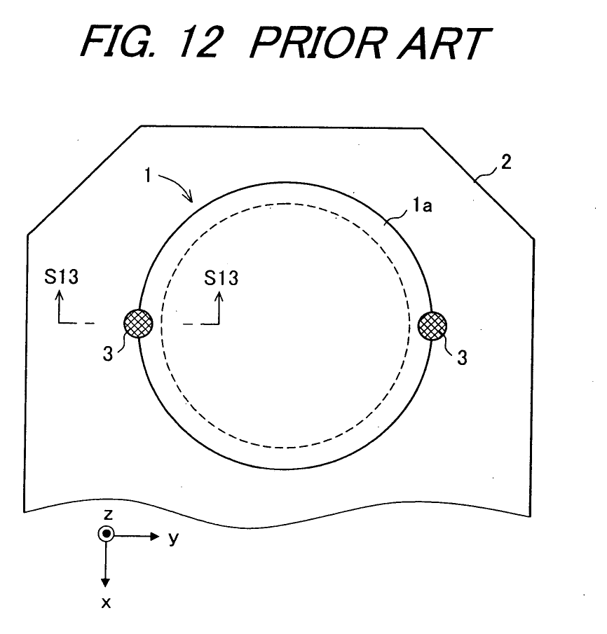

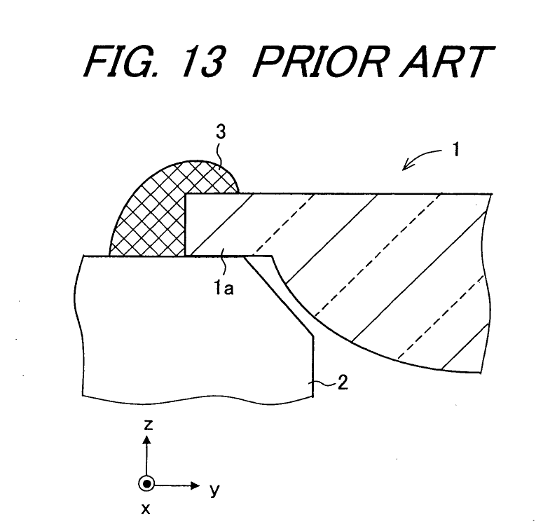

According to the optical pickup apparatus 10 of the embodiment, the condensing lens 16 has, in several positions about the outer periphery in the radial direction 19 thereof, the lens-side concavities 20 formed so as to open to face the optical recording medium 18. Then, that part of the condensing lens 16 which faces the lens-side concavity 20 is bonded to the lens holder 15 with the adhesive 21. Accordingly, as compared with the related art as shown in FIGS. 12 and 13 in which no lens-side concavity 20 is formed, the contact area between the condensing lens 16 and the adhesive 21 can be made wider. Therefore, the condensing lens 16 can be supported upon the lens holder 15 with stability. This makes it possible to increase the adhesion strength of the adhesive 21 against deterioration with age or temperature variations.

Moreover, according to the optical pickup apparatus 10 of the embodiment, the condensing lens 16 is provided with three or more lens-side concavities 20 that are equally spaced circumferentially. This allows, in the state in which the condensing lens 16 is bonded to the lens holder 15, the radial stress exerted on the condensing lens 16 to be uniformly distributed throughout the circumference thereof, and thereby minimizes the possibility of the condensing lens 16 being deformed that is associated with the prior art practice shown in FIG. 12.

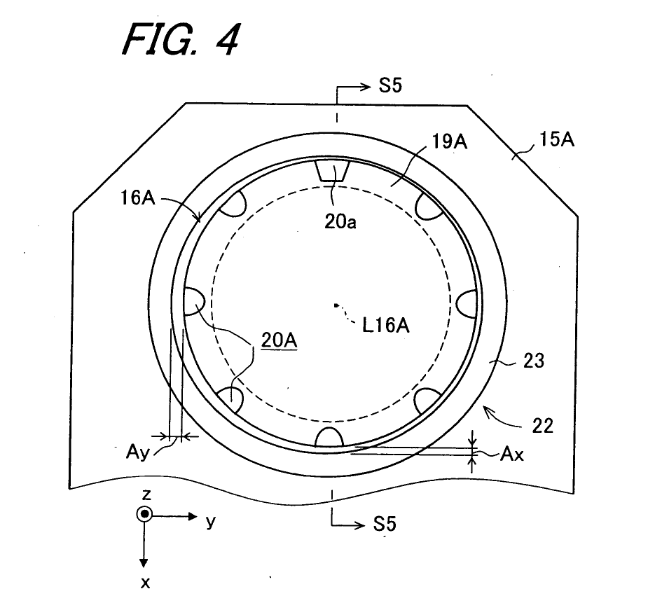

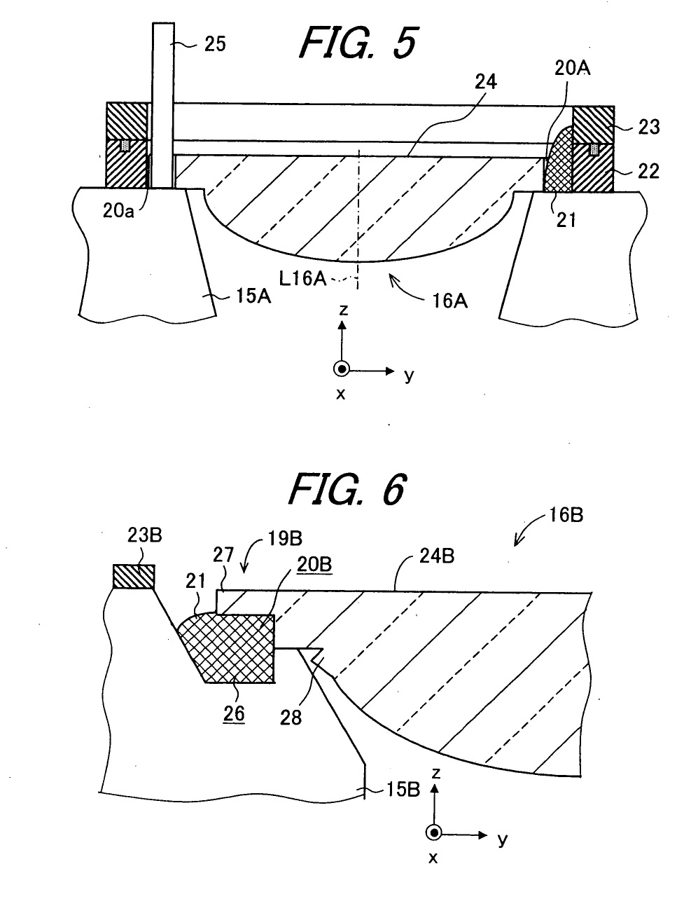

FIG. 4 is an enlarged plan view showing a lens holder 15A and a condensing lens 16A employed in an optical pickup apparatus 10A according to a second embodiment of the invention. FIG. 5 is a sectional view taken along the line S5-S5 of FIG. 4. In these drawings together with FIG. 1 to which reference is now made, the optical pickup apparatus 10A according to the second embodiment has basically the same structure as the above stated optical pickup apparatus 10 according to the first embodiment. Thus, only the different points will be explained hereinbelow.

The condensing lens 16A has, in several positions about an outer periphery in the radial direction 19A thereof, three pieces or more (eight pieces, in this embodiment) of lens-side concavities 20A equi-spaced circumferentially so as to open to face the optical recording medium 18. With use of the adhesive 21, that part of the condensing lens 16A which faces the lens-side concavity 20A is bonded to the lens holder 15A. Specifically, the lens-side concavity 20A is so formed as to open outward in the radial direction to face the lens holder 15A and the optical recording medium 18.

Of eight pieces of lens-side concavities 20A, one lens-side concavity 20a is sunk inward in the radial direction, and the surface of the condensing lens 16A facing the lens-side concavity 20A from the inner side in the radial direction is composed of a plurality (three pieces, in this embodiment) of planes contiguous to one another. The rest of the lens-side concavities 20A are each sunk inward in the radial direction, and the surface of the condensing lens 16A facing the lens-side concavity 20A from the inner side of the radiation direction is so shaped as to have a substantially cylindrical inner peripheral surface whose axis is parallel to the axis L16A of the condensing lens 16A. That is to say, one lens-side concavity 20a of the lens-side concavities 20A and the other lens-side concavity 20A are configured differently from each other.

The optical pickup apparatus 10A further includes a guide portion 22 and a lens protector 23. The guide portion 22 is disposed in the lens holder 15A so as to protrude therefrom toward the optical recording medium 18. The guide portion 22 extends along the entire circumference of the condensing lens 16A from the outer side in the radial direction thereof so as to encircle the condensing lens 16A. The lens protector 23, provided as a lens protective member, is formed in an annular shape and arranged on an optical-recording-medium-18 side with respect to the surface 24 of the condensing lens 16A facing the optical recording medium 18. Specifically, the lens protector 23 is attached to the guide portion 22.

The lens holder 15A has, in its part facing the lens-side concavity 20A, specifically, the differently configured lens-side concavity 20a, a jig 25 acting as a guide member attachably and detachably disposed so as to protrude in the direction toward the optical recording medium 18. The lens protector 23 is guided by the jig 25 and attached to the guide portion 22. As shown in FIG. 5, the adhesive 21 is applied in such a way that the lens holder 15A, that part of the condensing lens 16A which faces the lens-side concavity 20, the inner periphery of the guide portion 22, and the inner periphery of the lens protector 23 are bonded to one another.

According to the optical pickup apparatus 10A of the embodiment, the condensing lens 16A has, in several positions about the outer periphery in the radial direction 19A thereof, the lens-side concavities 20A formed so as to open to face the optical recording medium 18. Then, that part of the condensing lens 16A which faces the lens-side concavity 20A is bonded to the lens holder 15A with the adhesive 21. Accordingly, as compared with the related art as shown in FIGS. 12 and 13 in which no lens-side concavity 20A is formed, the contact area between the condensing lens 16A and the adhesive 21 can be made wider. Therefore, the condensing lens 16A can be supported upon the lens holder 15A with stability. This makes it possible to increase the adhesion strength of the adhesive 21 against deterioration with age or temperature variations.

According to the optical pickup apparatus 10A of the embodiment, the condensing lens 16A is provided with three or more lens-side concavities 20A that are equally spaced circumferentially. This allows, in the state in which the condensing lens 16A is bonded to the lens holder 15A, the radial stress exerted on the condensing lens 16A to be uniformly distributed throughout the circumference thereof, and thereby minimizes the possibility of the condensing lens 16A being deformed that is associated with the related art shown in FIG. 12.

According to the optical pickup apparatus 10A of the embodiment, one lens-side concavity 20a is configured differently from the other lens-side concavities 20A. At the time when the condensing lens 16A is bonded to the lens holder 15A, the differently configured lens-side concavity 20a serves as a mark for facilitating proper positioning.

According to the optical pickup apparatus 10A of the embodiment, the lens protector 23 can be attached to the lens holder 15A with ease in the following manner. At first, the jig 25 is attached to that part of the lens holder 15A which faces the lens-side concavity 20A. The jig 25 is so formed as to protrude in the direction toward the optical recording medium 18. Then, the lens protector 23 is guided by the jig 25 so that it is arranged on the optical-recording-medium-18 side with respect to the surface 24 of the condensing lens 16A facing the optical recording medium 18. Thereupon, the lens protector 23 is attached to the lens holder 15A. In addition, such a lens protector 23 is useful in preventing the condensing lens 16A from abutting against the optical recording medium 18.

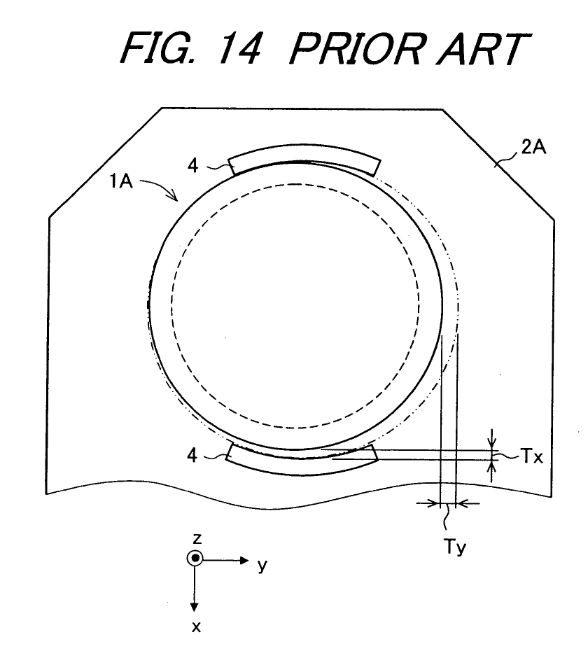

According to the optical pickup apparatus 10A of the embodiment, the lens holder 15A is provided with the guide portion 22 which extends along the entire circumference of the condensing lens 16A from the outer side in the radial direction thereof so as to encircle the condensing lens 16A. Thus, in contrast to the related art shown in FIG. 14 in which the guide portion 4 is disposed only in a given radial location, the condensing lens 16A can be positioned with respect to the lens holder 15A with maximum accuracy. Specifically, as shown in FIG. 4, it is assumed that the amount of displacement as seen in the x direction, namely, one radial direction of the condensing lens 16A, is Ax, and that the amount of displacement as seen in the y direction perpendicular to the axis of the condensing lens 1A and the x direction is Ay. In this case, the amount of displacement in the x direction Ax is substantially equivalent to the amount of displacement in the y direction Ay. As a result, in contrast to the related art shown in FIG. 14, the amount of deviation of the axis L16A of the condensing lens 16A from the desired position can be reduced.

According to the optical pickup apparatus 10A of the embodiment, the lens protector 23 is formed in the annular shape and attached to the guide portion 22. Thereby, the condensing lens 16A can be prevented from abutting against the optical recording medium 18 without fail.

For example, attachment of the lens protector 23 to the guide portion 22 may be carried out in the following manner. At first, convex fits are formed in several positions of the guide portion 22. Subsequently, concave fits are formed in the corresponding positions of the lens protector 23 so as to receive the convex fits of the guide portion 22. Then, the guide portion 22 and the lens protector 23 are fitted to each other at their convex and concave fits. It is needless to say that, also in this case, the attachment operation can be facilitated with use of the jig 25.

Moreover, the lens-side concavity 20a configured differently from the other lens-side concavities 20A may be formed by cutting off the gate which was obtained by pouring a synthetic resin into the mold during the production of the condensing lens 16A. Further, in the state in which the condensing lens 16A is supported upon the lens holder 15A, the lens-side concavity 20A may be formed symmetrically with the gate position where the influence of the aberration observed in the condensing lens 16A is at a minimum with respect to a virtual plane passing through the gate and the axis L16A of the condensing lens 16A.

FIG. 6 is an enlarged sectional view showing part of a lens holder 15B and a condensing lens 16B employed in an optical pickup apparatus 10B according to a third embodiment of the invention. In FIG. 6 together with FIG. 1 to which reference is now made, the optical pickup apparatus 10B according to the third embodiment has basically the same structure as the above stated optical pickup apparatus 10 according to the first embodiment. Thus, only the different points will be explained hereinbelow.

The condensing lens 16B has, in an outer periphery in the radial direction 19B thereof which outer periphery faces the optical recording medium 18, a lens-side concavity 20B formed so as to open to face the lens holder 15B. Meanwhile, the lens holder 15B has a holder-side concavity 26 formed therein so as to open to face the lens-side concavity 20B. The lens-side concavity 20B of the condensing lens 16B and the holder-side concavity 26 of the lens holder 15B are each formed in a total number of 3 or more. These concavities are equally spaced circumferentially. With use of the adhesive 21, that part of the condensing lens 16B which faces the lens-side concavity 20B is bonded to that part of the lens holder 15B which faces the holder-side concavity 26. Moreover, in the outer periphery in the radial direction 19B of the condensing lens 16B is formed a regulatory portion 27 extending from the optical-recording-medium-18 side to the lens-side concavity 20B, for regulating that the adhesive 21 is placed on the optical-recording-medium-18 side beyond the surface 24B of the condensing lens 16B facing the optical recording medium 18.

Specifically, the lens-side concavity 20B is so formed as to open outward in the radial direction to face the lens holder 15B. More specifically, the lens-side concavity 20B is sunk inward in the radial direction, and the surface of the condensing lens 16B facing the lens-side concavity 20B from the inner side in the radial direction is so shaped as to have a substantially cylindrical inner peripheral surface whose axis is parallel to the axis of the condensing lens 16B. In this way, the surface of the condensing lens 16B facing the lens-side concavity 20B is smoothed out, whereby making it possible to minimize the risk of damage to the condensing lens 16B caused by the stress concentration exerted on that part. Moreover, the lens-side concavity 20B and the holder-side concavity 26 communicate with each other. The condensing lens 16B can be readily bonded to the lens holder 15B simply by charging the adhesive 21 into the lens-side concavity 20B and holder-side concavity 26 from the outer side in the radial direction of the lens-side concavity 20B.

The condensing lens 16B is provided with a lens-side regulatory portion 28 for regulating that the adhesive 21 flows inward in the radial direction of the condensing lens 16B. Specifically, the lens-side regulatory portion 28 is so formed as to extend throughout an outer edge of a light-transmitting effective area in the internal part in the radial direction of the condensing lens 16B, and protrude outward in the radial direction. Moreover, the lens holder 15B has a lens protector 23B which is so arranged as to lie on the optical-recording-medium-18 side with respect to the surface 24B of the condensing lens 16B facing the optical recording medium 18. The lens protector 23B is located on the outer side in the radial direction of the condensing lens 16B.

According to the optical pickup apparatus 10B of the embodiment, the condensing lens 16B has, in the outer periphery in the radial direction 19B thereof which outer periphery faces the optical recording medium 18, the lens-side concavity 20B formed so as to open to face the lens holder 15B. Meanwhile, the lens holder 15B has the holder-side concavity 26 formed therein so as to open to face the lens-side concavity 20B. With use of the adhesive 21, that part of the condensing lens 16B which faces the lens-side concavity 20B is bonded to that part of the lens holder 15B which faces the holder-side concavity 26. Accordingly, as compared with the case where neither the lens-side concavity 20B nor the holder-side concavity 26 is formed, the contact area among the lens holder 15B, the condensing lens 16B and the adhesive 21 can be made wider. Therefore, the condensing lens 16B can be supported upon the lens holder 15B with stability.

According to the optical pickup apparatus 10B of the embodiment, the condensing lens 16B is provided with the regulatory portion 27 for regulating that the adhesive 21 is placed on the optical-recording-medium-18 side beyond the surface of the condensing lens 16B facing the optical recording medium 18. This makes it possible to prevent the adhesive 21 from jutting into the optical-recording-medium-18 side beyond the surface 24B of the condensing lens 16B facing the optical recording medium 18, and thereby keep the adhesive 21 out of contact with the optical recording medium 18 without fail.

According to the optical pickup apparatus 10B of the embodiment, the lens-side concavity 20B of the condensing lens 16B and the holder-side concavity 26 of the lens holder 15B are each formed in a total number of 3 or more, and these concavities are equally spaced circumferentially. This allows, in the state in which the condensing lens 16B is bonded to the lens holder 15B, the radial stress exerted on the condensing lens 16B to be uniformly distributed throughout the circumference thereof, and thereby minimizes the possibility of the condensing lens 16B being deformed.

According to the optical pickup apparatus 10B of the embodiment, the lens protector 23B is formed in the annular shape. This makes it possible to minimize the possibility of the condensing lens 16B abutting against the optical recording medium 18.

According to the optical pickup apparatus 10B of the embodiment, the condensing lens 16B is provided with the lens-side regulatory portion 28 for regulating that the adhesive 21 flows inward in the radial direction of the condensing lens 16B. This makes it possible to prevent the adhesive 21 from flowing toward the light-transmitting area in the internal part in the radial direction of the condensing lens 16B, and thereby minimize the possibility of the light being inhibited from transmission.

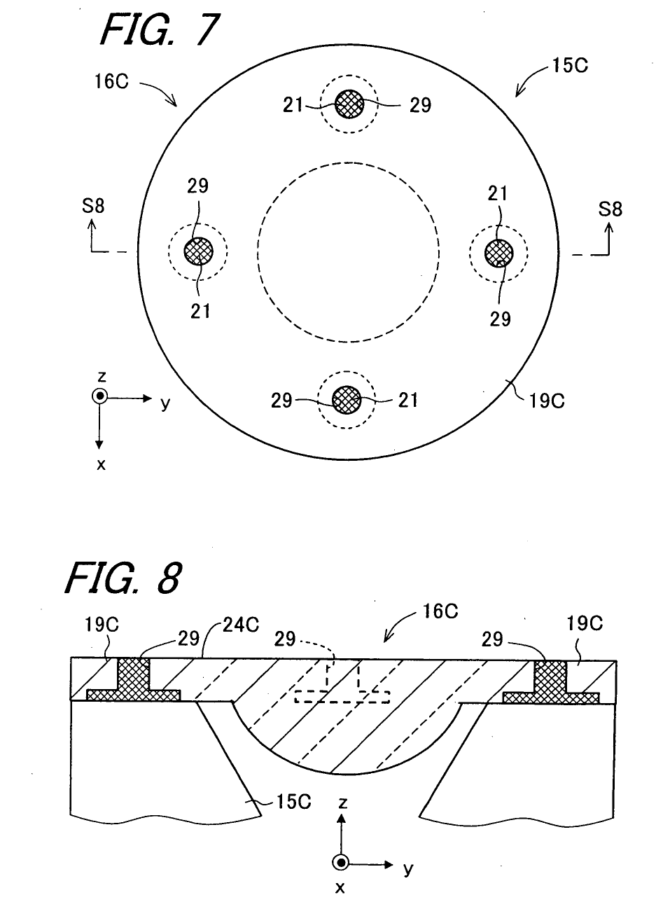

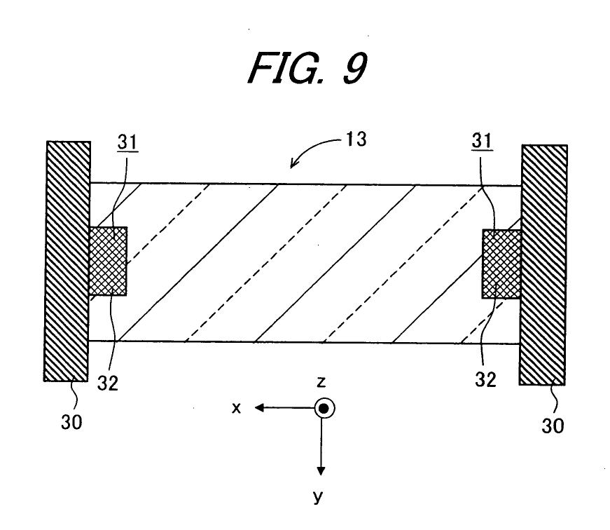

FIG. 7 is an enlarged plan view showing a lens holder 15C and a condensing lens 16C employed in an optical pickup apparatus 10C according to a fourth embodiment of the invention. FIG. 8 is a sectional view taken along the line S8-S8 of FIG. 7. In these drawings together with FIG. 1 to which reference is now made, the optical pickup apparatus 10C according to the fourth embodiment has basically the same structure as the above stated optical pickup apparatus 10 according to the first embodiment. Thus, only the different points will be explained hereinbelow.

The condensing lens 16C has, in several positions about an outer periphery in the radial direction 19C thereof, three pieces or more (four pieces, in this embodiment) of through holes 29 equi-spaced circumferentially so as to open to face the optical recording medium 18 and the lens holder 15C. The through hole 29 is so shaped that its part facing the lens holder 15C is made larger in diameter than the rest part thereof. With the adhesive 21, that part of the condensing lens 16C in which the through hole 29 is formed is bonded to that part of the lens holder 15C which faces the through hole 29. At this time, the adhesive 21 is placed on the lens-holder-15C side with respect to the surface 24C of the condensing lens 16C facing the optical recording medium 18. This makes it possible to prevent the adhesive 21 from jutting into the optical-recording-medium-18 side beyond the surface 24C of the condensing lens 16C facing the optical recording medium 18, and thereby keep the adhesive 21 out of contact with the optical recording medium 18.

According to the optical pickup apparatus 10C of the embodiment, the condensing lens 16C has, in several positions about the outer periphery in the radial direction 19C thereof, the through holes 29 formed so as to open to face the optical recording medium 18 and the lens holder 15C. Then, a through hole formed portion of the condensing lens 16C in which the through hole 29 is formed is bonded to the lens holder 15C with the adhesive 21. Accordingly, as compared with the related art as shown in FIGS. 12 and 13 in which no through hole 29 is formed, the contact area between the condensing lens 16C and the adhesive 21 can be made wider. Therefore, the condensing lens 16C can be supported upon the lens holder 15C with stability.

According to the optical pickup apparatus 10C of the embodiment, three or more through holes 29 are equally spaced circumferentially. This allows, in the state in which the condensing lens 16C is bonded to the lens holder 15C, the radial stress exerted on the condensing lens 16C to be uniformly distributed throughout the circumference thereof, and thereby minimizes the possibility of the condensing lens 16C being deformed that is associated with the related art shown in FIG. 12.

According to the optical pickup apparatus 10C of the embodiment, the through hole 29 is so shaped that its part facing the lens holder 15C is made larger in diameter than the rest part thereof. This makes it possible to increase the adhesive coating area between the lens holder 15C and the through hole formed portion. Therefore, the condensing lens 16C can be supported upon the lens holder 15C with more stability.

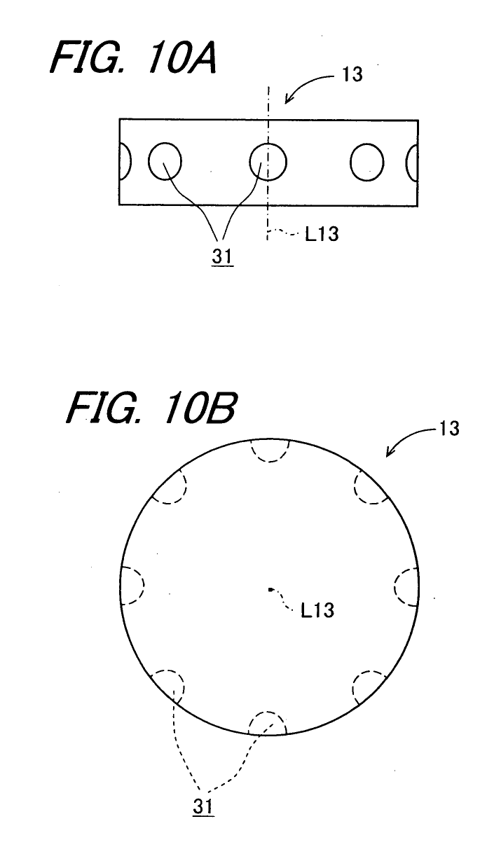

FIG. 9 is a sectional view showing the collimator lens 13 employed in the optical pickup apparatuses 10, 10A, 10B, and 10C according to the first to fourth embodiments. Fig. 10A is a side view showing one embodiment of the collimator lens 13, and Fig. 10B is a front view showing one embodiment of the collimator lens 13. As shown in FIG. 9, the collimator lens 13 is adhesively supported upon a housing 30. As shown in Figs. 10A and 10B, the collimator lens 13 has, in a middle part in an axial direction L13 of an outer periphery thereof, a plurality (eight pieces, in this embodiment) of concavities 31 equi-spaced circumferentially so as to be sunk inward in the radial direction but to open outward in the radial direction. Then, adhesive 32 is charged into the concavity 31, and thereby that part of the collimator lens 13 which faces the concavity 31 is bonded to the housing 30.

As described just above, the collimator lens 13 is provided with a plurality of, preferably, three or more concavities 31 that are evenly spaced circumferentially. This allows, in the state in which the collimator lens 13 is bonded to the housing 30, the radial stress exerted on the collimator lens 13 to be uniformly distributed throughout the circumference thereof, and thereby minimizes the possibility of the collimator lens 13 being deformed.

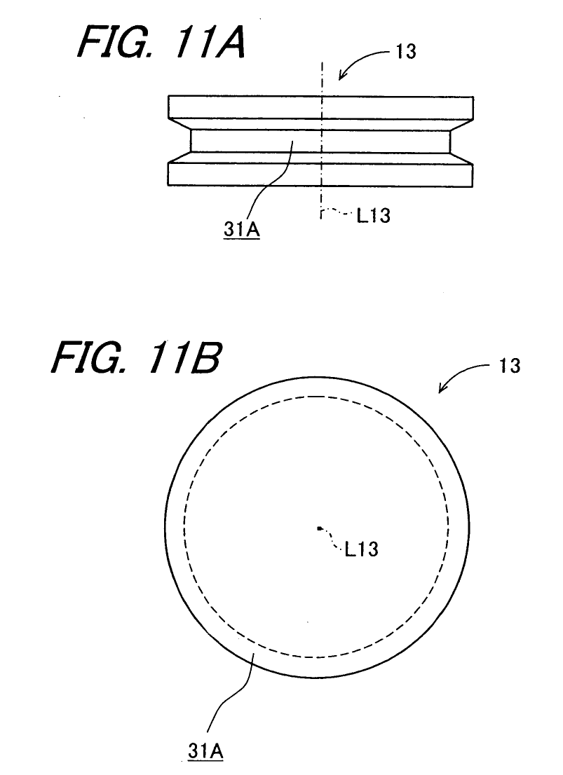

FIG. 11A is a side view showing another embodiment of the collimator lens 13, and FIG. 11B is a front view showing another embodiment of the collimator lens 13. As shown in FIG. 9, the collimator lens 13 is bonded to and supported upon the housing 30. As shown in FIGS. 11A and 11B, the collimator lens 13 has, in the middle part in the axial direction L13 of an outer periphery thereof, a concavity 31A extending circumferentially so as to be sunk inward in the radial direction but to open outward in the radial direction. Then, the adhesive 32 is charged into the concavity 31A, and thereby that part of the collimator lens 13 which faces the concavity 31A is bonded to the housing 30.

As described just above, the collimator lens 13 is provided with the concavity 31A extending circumferentially. This allows, in the state in which the collimator lens 13 is bonded to the housing 30, the radial stress exerted on the collimator lens 13 to be uniformly distributed throughout the circumference thereof, and thereby minimizes the possibility of the collimator lens 13 being deformed.

In any of the optical pickup apparatuses 10, 10A, 10B, and 10C according to the first to fourth embodiments, even if the optical pickup apparatus is made compact and lower in profile, it is possible to secure stable adhesion strength suitable for bonding a variety of optical components. As a result, the positional deviation of the optical components, which can be attributed to deterioration with age or temperature variations, can be minimized. This makes it possible to represent a notable contribution to improvement in the performance and service life of the optical pickup apparatus.

In any of the optical pickup apparatuses 10, 10A, 10B, and 10C according to the first to fourth embodiments, the lens-side concavities 20, 20A, 20B; the holder-side concavity 26; and the through hole 29 may be appropriately modified in configuration.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An optical pickup apparatus comprising:
a condensing lens for gathering light emitted from a light source on an object to be irradiated; and
a lens holder for supporting the condensing lens,
wherein the condensing lens has, in an outer periphery in a radial direction thereof, a lens-side concavity formed so as to open to face the object to be irradiated,
and wherein that part of the condensing lens which faces the lens-side concavity is bonded to the lens holder with use of an adhesive.

2. The optical pickup apparatus of claim 1, wherein the condensing lens is provided with three or more lens-side concavities that are equally spaced circumferentially.

3. The optical pickup apparatus of claim 2, wherein one of the lens-side concavities is configured differently from the other lens-side concavities.

4. The optical pickup apparatus of claim 3, wherein a guide member is detachably attached to that part of the lens holder facing the lens-side concavity so as to protrude in a direction toward the object to be irradiated, and wherein
a lens protective member is guided by the guide member so that the lens protective member is arranged on the object-to-be-irradiated side with respect to a surface of the condensing lens facing the object to be irradiated.

5. The optical pickup apparatus of claim 1, wherein the lens holder is provided with a guide portion which extends along the entire circumference of the condensing lens from an outer side in the radial direction thereof so as to encircle the condensing lens.

6. The optical pickup apparatus of claim 5, wherein the lens protective member is formed in an annular shape and is attached to the guide portion.

7. An optical pickup apparatus comprising:
a condensing lens for gathering light emitted from a light source on an object to be irradiated; and
a lens holder for supporting the condensing lens,
wherein the condensing lens has, in an outer periphery in a radial direction thereof which outer periphery faces the object to be irradiated, a lens-side concavity formed so as to open to face the lens holder,
wherein the lens holder has a holder-side concavity formed therein so as to open to face the lens-side concavity,
and wherein that part of the condensing lens which faces the lens-side concavity is bonded to that part of the lens holder which faces the holder-side concavity with use of an adhesive.

8. The optical pickup apparatus of claim 7, wherein the condensing lens is provided with a regulatory portion for regulating that the adhesive is placed on an object-to-be-irradiated side beyond a surface of the condensing lens facing the object to be irradiated.

9. The optical pickup apparatus of claim 7, wherein the condensing lens is provided with three or more lens-side concavities that are equally spaced circumferentially.

10. The optical pickup apparatus of claim 7, further comprising a lens protective member formed in an annular shape,
wherein the lens protective member is attached to the lens holder so that the lens protective member is arranged on the object-to-be-irradiated side with respect to a surface of the condensing lens facing the object to be irradiated and on an outer side in the radial direction of the condensing lens.

11. The optical pickup apparatus of claim 7, wherein the condensing lens is provided with a lens-side regulatory portion for regulating that adhesive flows inward in the radial direction of the condensing lens.

12. An optical pickup apparatus comprising:
a condensing lens for gathering light emitted from a light source on an object to be irradiated; and
a lens holder for supporting the condensing lens,
wherein the condensing lens has, in an outer periphery in a radial direction thereof, a through hole formed so as to open to face the object to be irradiated and the lens holder,
and wherein a through hole formed portion of the condensing lens in which the through hole is formed is bonded to the lens holder with use of an adhesive.

13. The optical pickup apparatus of claim 12, wherein the through hole is so shaped that its part facing the lens holder is made larger in diameter than the rest part thereof.

14. An electronic apparatus having the optical pickup apparatus of claim 1 mounted therein.

15. An electronic apparatus having the optical pickup apparatus of claim 7 mounted therein.

16. An electronic apparatus having the optical pickup apparatus of claim 12 mounted therein.
